(19) United States
(12) Patent Application Publication
(10) Pub. No.: US 2005/0208191 A1
(43) Pub. Date: Sep. 22, 2005

(54) Process for the preparation of a high protein nutritious baked snack food

(76) Inventors: Ragu Saimanohar, Mysore (IN); Rathinam Vetrimani, Mysore (IN); Krishnarau Leelavathi, Mysore (IN); Punaroor Haridas Rao, Mysore (IN); Thekkar Ratnakar Prabhu, Mysore (IN); Vishweshwaraiah Prakash, Mysore (IN)

Correspondence Address: SCHWEITZER CORNMAN GROSS & BONDELL LLP, 292 MADISON AVENUE - 19th FLOOR, NEW YORK, NY, 10017, US

(21) Appl. No.: 10/805,163

(22) Filed: Mar. 19, 2004

(51) Int. Cl. A21D 10/00

(52) U.S. Cl. 426/549

(57) ABSTRACT

Snack food can be source of high energy and high protein for children and adult supplementing their nutritional requirement. Preparation of a high protein nutritional baked snack food comprises of vegetable sources as wheat flour, roasted peanut paste, sesame seed, soybean flour and well balanced mixture of vitamins, minerals and others. Ingredients dissolved in formula water after powdering, dehulling as required etc. are mixed to get homogenous dough. Dough is sheeted and cut using circular die of 3.0-4.0 mm diameter. It is baked at 180-220° C. for 4-6 min.

The present invention relates to a process for the preparation of a high protein nutritious baked snack food.

Inadequate intake of nutritionally balanced foods due to various socioeconomic reasons make individuals especially children vulnerable to various infectious diseases which often results in morbidity and mortality. Major nutritional problems prevalent in most of the developing countries are protein-calorie malnutrition, vitamin ‘A’ defiency and iron deficiency and iodine deficiency. Providing health foods fortified with critical vitamins and minerals reduces risk of malnutrition, especially in children.

‘Snack-foods’ or ‘snacks’ are popular food items which are easily consumed, readily available, small-sized products, in liquid or solid form, requiring little or no preparation for consumption (Estevez, A. M., Escobar, B., Vasquez, M., Castillo, E., Araya, E. and Zacarias, I. 1995. Cereal and Plant Foods for Human Nutrition. Cereal and nut bars, nutritional quality and storage stability. 47 : 309-317). Snack foods are preferred by children and adults as well and hence can be a source of high-energy and high-protein content and could play important role in their physical and mental well being supplying their everyday nutritional requirements.

Most of the snack foods, in order to meet their energy and protein requirements use sources such as walnuts (Estevez, A. M., Escobar, B., Vasquez, M., Castillo, E. and Zacarias, I. 1995. Cereal and Plant Foods for Human Nutrition. Cereal and nut bars, nutritional quality and storage stability. 47: 309-317.); egg proteins (Jan M. Wiker and Franklin E. Cunningham. 1983. U.S. Pat. No. 4,421,770); whey protein (Henry J. Huelskamp, John J. Collins, and James E. Devero. 1975. U.S. Pat. No. 3,911,142), and meat, poultry and fish proteins (Paul W. Hait, 1978. U.S. Pat. No. 4,126,705). These food materials are used to make the snack-food rich in proteins only and might not necessarily provide other nutrients such as vitamins and minerals in adequate amounts.

Apart from the above sources health snack food can also acquire its proteins from protein-rich vegetable sources such as defatted soy bean flour, peanuts, sesame seeds, and wheat germ.

Soybean is one of the richest sources of protein with defatted flour containing about 55% protein of high nutritional value. The world soybean production is about 159 million metric tons while its production in India is around 6.1 million metric tonnes (2000 soya and oilseed Blue Book. Editor: Peter Golbitz. Published by Soyatech, Inc. USA). One of the promising uses of soybeans is the fortification of cereal-based products, because the profile of essential amino acids in soybean is complementary to that in most cereals and supplies all the essential amino acids (Riaz, M. N. 1999. Healthy baking with Soy ingredients. Cereal Foods World. 44; 136-139).

Peanuts are one of the world's leading oilseed crops. It is the world's third most important sources of vegetable proteins (Lucas, E. W. 1979. Food uses of Peanut protein (Journal of the American Oil Chemists' Society. Vol. 56, 425-430). The world production of peanuts is approximately 31 million metric tonnes for 1998, out of which India produced 8.3 million metric tonnes. This accounts for nearly 25% of the entire world production of peanuts (FAO Quarterly Bulletin of Statistics. Vol. II, No. 3, 1998. Food and Agricultural Organization of United Nations, Rome, Italy, PP 56-72; The Hindu survey of Indian Agriculture, 1999. Publisher: Rangarajan, Chennai, Editor: N. Ravi, Chennai). Protein content of peanut is in the range of 20 to 35%.

Sesame seed is another tropical oil seed, which is uniquely grown in India. The world production of sesame seed is about 3.7 million metric tonnes for the year 1997. India is a major producer of sesame in the world with nearly 1.5 million metric tonnes. Protein content of sesame seeds range from 20-30%. The sesame protein is a rich source of the essential amino acid methionine.

Wheat germ is a by-product of the roller flour milling industry. Wheat germ, which constitutes 2.5 to 3.0% of the grain, can be separated in a fairly pure form. In India totally about 180,000 tonness of germ can be obtained annually. Wheat germ contains about 30% proteins of excellent quality. Appropriate heat treatments of the wheat germ improves its nutritive value considerably (Kumar, G. V., Emilia Verghese, T., Haridas Rao, P., and Shurpalekar, S. R. 1980. Effect of heat treatment on the nutritive value of wheat germ. Journal of Food Science and Technology. Vol. 17 : 256-258). Such processed germ can be used with advantage for the protein enrichment of processed foods.

Reference may be made to Jan M. Wiker and Franklin E. Cunningham (U.S. Pat. No. 4,421,770) wherein a high protein snack food is prepared from egg protein. The drawback is the use of egg protein which might not be acceptable by all stratum of the population.

Reference may be made to Dieken Laurel M.; Mickle James B; and Smith Wanda J (U.S. Pat. No. 4,183,966) wherein a method is described for the manufacture of high protein snack food. The drawbacks are use of egg whites and whey proteins and the product is extruded, fried and cooked in microwave oven.

Reference may be made to Brothers J. Alfred; and Chahine M. Helmy (U.S. Pat. No. 4,212,892) wherein a method for preparing a high-protein snack food is described. The drawbacks are the use of fish and/or soybean gel and the product is extruded into desired shape and cooked.

Reference may be made to Ray Earl E. (WO 99305666) wherein nutritious, low calorie, low cholesterol, shelf-stable expanded snack food product is disclosed. The drawback is using of proteinaceous material such as meats which might not be acceptable to all stratum of society.

Reference may be made to Heng Lu (CN1135838) wherein biscuits with proteins from oil materials are prepared. The drawback is the use of degreased sesame seed powder and de-oiled peanut protein powder.

Reference may be made to Deininger Rolf, and Wolf Erich (U.S. Pat. No. 3,976,800) wherein a high-protein, low-carbohydrate, low-fat bar is produced. The drawback is the ingredients are shaped into a bar which solidifies on standing.

Reference may be made to Ray Earl (U.S. Pat. No. 5,290,584) wherein a nutritious, low calorie, low cholesterol, shelf-stable expanded snack food product is disclosed. The drawback is using of proteinaceous such as meats which might not be acceptable to all stratum of society.

Reference may be made to Ray Earl (U.S. Pat. No. 5,283,077) wherein a method for the preparation of a nutritious, low-calorie, low cholesterol, shelf-stable, expanded food product is disclosed. The drawbacks are meat is used as the proteinaceous material and the product is extruded.

Reference may be made to Gerber Prod (Patent Number GB2041716) wherein a dehydrated high protein snack food is produced. The drawbacks are the use of a dairy protein and subjecting the snacks to heating with and without live steam at 375° F. respectively.

Reference may be made to Henry J. Huelskamp; John J. Collins; and James E. Devero; (U.S. Pat. No. 3,911,142) wherein a ready to eat snack food product which is high in protein content is disclosed. The drawback is the use of whey and potato flakes.

Reference may be made to Paul W. Hait (U.S. Pat. No. 4,126,705) wherein a dehydrated protein snack food using raw meat, poultry, fish and vegetable protein is prepared. The drawback is the use of meat as source of protein which might not be acceptable by all stratum of the population.

Reference may be made to Clande Giddey (U.S. Pat. No. 4,039,694) wherein a process for protein-based food is disclosed. The drawback is the use of partially dehydrated homogenous mass of aqueous vegetable protein gel.

Reference may be made to Russell G. Mckenzie (U.S. Pat. No. 6,143,335) wherein a process is claimed for the preparation of a nutritional food. The drawback is product is extruded.

The main object of the present invention is to provide a composition for high-protein nutritious baked snack food and a process for the preparation of the same.

Another object of the present invention is to use several vegetable sources rich in protein such as defatted soy flour, sesame seeds, peanuts and wheat germ.

Yet another object of the present invention is to use a well balanced mixture of several vitamins and minerals to enhance the nutritional value of the final product.

Accordingly the present invention provides a composition for a high-protein nutritional baked snack food comprising:

| | Kg |
|---|---|
| Whole wheat flour | 70-80 |
| Roasted (defatted) soy flour | 30-20 |
| Peanut paste (from roasted | 8-12 |
| peanuts) | |
| Sesame seed paste (from roasted | 2-4 |
| Sesame seeds) | |
| Sesame seed (roasted) | 1-3 |
| Wheat germ (roasted) | 3-7 |
| Non fat dry milk (fat content <1%) | 3-7 |
| Sugar powder (+120μ sieve) | 35-45 |
| Liquid glucose | 2-3 |
| Fat (M.P. 40° C.) | 9-13 |
| Lecithin (soy) | 0.3-0.5 |
| Sodium Chloride | 0.5-1.5 |
| Ammonium bicarbonate | 0.8-1.2 |
| Baking powder | 0.30-0.55 |
| Flavoring agents (ml) | 0.1-0.30 |
| (cardamom flavor) | |
| MINERALS (Grams) | |
| Iron | 5.77-7.07 |
| Zinc | 12.38-15.15 |
| Copper | 0.41-0.51 |
| Iodine | 0.16-0.20 |
| Magnesium | 0.79-0.97 |
| VITAMINS (Grams) | |
| Vitamin - A | 0.23-0.28 |
| Vitamin - D | 0.0058-0.0071 |
| Vitamin - E | 0.41-0.51 |
| Vitamin - K | 0.49-0.61 |
| Vitamin B1 (Thiamine) | 0.41-0.51 |
| Vitamin B2 (Riboflavin) | 0.46-0.57 |
| Nicotinic acid | 4.13-5.05 |
| Pyridoxine | 0.49-0.61 |
| Folic acid | 0.015-0.018 |
| Pantothenic acid | 0.0005-0.0006 |
| Vitamin - C | 19.80-24.25 |
| Biotin | 0.16-0.20 |
| Inositol | 0.825-1.01 |
| Choline bitartarate | 2.06-2.52 |
| Vitamin - B12 | 0.00049-0.00061 |

In an embodiment of the present invention a process for the preparation of high protein nutritious baked snack food comprises (i) powdering the wheat kernels in a disc mill resulting in whole wheat flour to pass through 10xx (129μ) sieve, (ii) roasting the defatted soy flour in a fluidized bed roaster for a period of 5-12 minutes at 200-220° C., (iii) roasting of peanuts in a fluidized bed roaster for a period of 5-15 minutes at 280-320° C., (iv) dehulling of roasted peanuts in a brush finisher, (v) converting the roasted and dehulled peanuts into a fine paste in an electric grinder, (vi) roasting of sesame seeds in a fluidized bed roaster for a period of 4-6 minutes at 280-320° C., (vii) converting required portion of roasted sesame seeds into a fine paste in an electric grinder, (viii) roasting of wheat germ in a fluidized bed roaster for a period of 3-5 minutes at 280-320° C., (ix) homogenous mixing of vitamins namely, vitamin A, vitamin D, vitamin E, vitamin K, vitamin B1 (thiamine), vitamin B2 (riboflavin), nicotinic acid, pyridoxine, folic acid, pantothenic acid, biotin, inositol, choline bitartarate, vitamin B12 and vitamin C, and minerals, namely, iron, zinc, copper, iodine and magnesium, along with 200-300 g of whole wheat flour for a period of 5-10 minutes to form the vitamin and mineral premix, (x) preparing a blend of 70-80% by weight of whole wheat flour, 20-30% by weight of roasted defatted soy flour, 4-6% by weight of non fat dry milk, and 0.3-0.5% by weight of baking powder, (xi) dissolving ammonium bicarbonate and sodium chloride in formula water, (xii) transferring peanut paste from step-v, sesame seed paste from step-vii, roasted wheat germ from step-viii, vitamin and mineral premix from step-ix, blend of whole wheat flour, soy flour, milk powder and baking powder from step-x, other ingredients such as roasted whole sesame seed, sugar powder, fat, liquid glucose, lecithin, flavoring agent, ammonium bicarbonate and sodium chloride dissolved in formula water as obtained in step-xi, into a mixer and mixing for 15-20 minutes into a homogenous dough, (xiii) sheeting the dough to a thickness of 1.5 mm-2.0 mm, (xiv) docking and cutting the sheeted dough into circular shape, (xv) baking in a conventional oven at 180-220° C. for 4-6 minutes to get the high protein nutritious baked snackfood.

In another embodiment of the present invention commercially available wheat used is with 9.0-10.0% moisture, 1.1-1.5% ash, 9.2-10.0% protein content.

In yet another embodiment of the present invention wheat kernels are processed into flour in a disc mill to pass through 10xx (129μ) sieve.

In yet another embodiment of the present invention defatted soy flour is roasted in a fluidized bed roaster at 200-220° C. for a period of 5-12 minutes.

In yet another embodiment of the present invention peanuts are roasted in a fluidized bed roaster maintained at 280-320° C. for 5-15 minutes.

In yet another embodiment of the present invention roasted peanuts are dehulled in a brush finisher.

In yet another embodiment of the present invention roasted and dehulled peanuts are made into a fine paste in an electric grinder.

In yet another embodiment of the present invention sesame seeds are roasted in a fluidized bed roaster for a period of 4-6 minutes at 280-320° C.

In yet another embodiment of the present invention required portion of the roasted sesame seeds are made into a fine paste in an electric grinder.

In yet another embodiment of the present invention wheat germ is roasted in a fluidized bed roaster for a period of 3-5 minutes at 280-320° C.

In still another embodiment of the present invention vitamins namely, vitamin A, vitamin D, vitamin E, vitamin K, vitamin B1 (thiamin), vitamin B2 (riboflavin), nicotonic acid, pyridoxine, folic acid, pantothenic acid, biotin, inositol, choline bitartarate, vitamin B12 and vitamin C; and minerals namely iron, zinc, copper, iodine and magnesium are mixed into a homogenous blend along with 200-300 g of whole wheat flour for a period of 5-10 min to obtain the vitamin and mineral premix.

In still another embodiment of the present invention whole wheat flour, roasted defatted soy flour, non fat dry milk and baking powder are thoroughly mixed for about 10-12 minutes into a homogenous mixture.

In still another embodiment of the present invention ammonium bicarbonate and sodium chloride are dissolved in formula water.

In still another embodiment of the present invention peanut paste, sesame seed paste, roasted wheat germ, vitamin-mineral premix, blend of whole wheat flour-soy flour-milk powder-baking powder, roasted sesame seed, sugar powder, fat, liquid glucose, lecithin, flavoring agent, ammonium bicarbonate and sodium chloride dissolved in formula water are transferred to a mixer and mixed for 15-20 minutes into a homogenous dough.

In still another embodiment of the present invention the dough is sheeted to a thickness of 1.5-2.0 mm.

In still another embodiment of the present invention sheeted dough is docked and cut using a circular die of about 3.0-4.0 mm diameter.

In still another embodiment of the present invention the cut dough is baked in a conventional oven at 180-220° C. for 4-6 minutes to get the high protein nutritious baked snack food.

In still another embodiment of the present invention the snack food is cooled and packed.

The following formulation in the range with alterations wherever required was used for the preparation of high protein nutritious baked snack food.

| MATERIAL | QUANTITY (Kg) |
|---|---|
| Whole wheat flour | 70-80 |
| Roasted (defatted) soy flour | 30-20 |
| Peanut paste (from roasted | 8-12 |
| peanuts) | |
| Sesame seed paste (from roasted | 2-4 |
| Sesame seeds) | |
| Sesame seed (roasted) | 1-3 |
| Wheat germ (roasted) | 3-7 |
| Non fat dry milk (fat content <1%) | 3-7 |
| Sugar powder (+120μ sieve) | 35-45 |
| Liquid glucose | 2-3 |
| Fat (M.P. 40° C.) | 9-13 |
| Lecithin (soy) | 0.3-0.5 |
| Sodium Chloride | 0.5-1.5 |
| Ammonium bicarbonate | 0.8-1.2 |
| Baking powder | 0.30-0.55 |
| Flavoring agents (ml) | 0.1-0.30 |
| (cardamom flavor) | |
| MINERALS (Grams) | |
| Iron | 5.77-7.07 |
| Zinc | 12.38-15.15 |
| Copper | 0.41-0.51 |
| Iodine | 0.16-0.20 |
| Magnesium | 0.79-0.97 |
| VITAMINS (Grams) | |
| Vitamin - A | 0.23-0.28 |
| Vitamin - D | 0.0058-0.0071 |
| Vitamin - E | 0.41-0.51 |
| Vitamin - K | 0.49-0.61 |
| Vitamin B1 (Thiamine) | 0.41-0.51 |
| Vitamin B2 (Riboflavin) | 0.46-0.57 |
| Nicotinic acid | 4.13-5.05 |
| Pyridoxine | 0.49-0.61 |
| Folic acid | 0.015-0.018 |
| Pantothenic acid | 0.0005-0.0006 |
| Vitamin - C | 19.80-24.25 |
| Biotin | 0.16-0.20 |
| Inositol | 0.825-1.01 |
| Choline bitartarate | 2.06-2.52 |
| Vitamin - B12 | 0.00049-0.00061 |
| | 165.05-198.11 |
| Moisture content of snack food | 3.53-3.53 |
| | 168.58-201.64 |
| Production loss (0.5%) + Process deficit (0.5%) | 1.68-2.02 |
| Production loss due to aerating chemicals (0.75%) | 0.95-1.48 |
| | 165.95-198.14 |

Yield of product per 100 Kg flour blend (whole wheat flour + roasted soy flour) is 165.95-198.14 Kg.

The different unit operations and conditions involved in the preparation of high protein nutritious baked snack food prepared using whole wheat flour, defatted soy flour, peanut paste, sesame seed paste, sesame seed, wheat germ, non fat dry milk, and selected minerals and vitamins are given in the following flow chart.

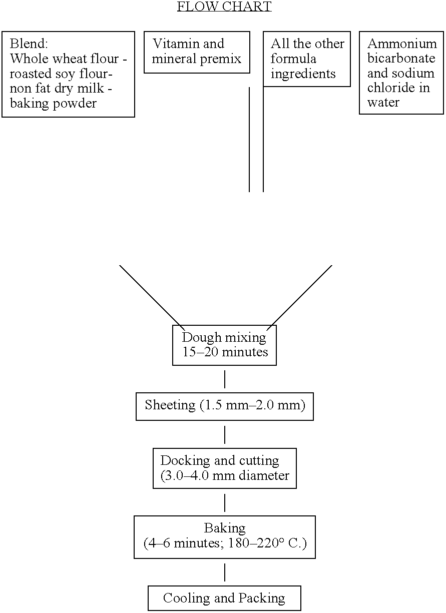

The following examples are given by way of illustration of the present invention and therefore should not be construed to limit the scope of the present invention.

### EXAMPLE-1

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Subjective evaluation showed that the product prepared without fat in the formulation was uneven with lot of blisters on the surface. The product also had shrunken, dull and dry appearance. The product had a very dry mouthfeel and had very hard texture.

Objective evaluation showed that product had a width of 49.8 mm and a thickness of 4.0 mm. The spread ratio was 12.45. Objective evaluation showed that it had a breaking strength of 2.73 Kg.

| | | | | Breaking |
|---|---|---|---|---|
| | Width (W), | Thickness (T) | Spread ratio | strength |
| Sample | (mm) | (mm) | (W/T) | (Kg Force) |
| No Fat | 49.8 | 4.0 | 12.45 | 2.73 |

### EXAMPLE-2

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 10.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Subjective evaluation showed that the product had a smooth surface without any surface blisters. The product also had a wholesome appearance and uniform surface colour. The snack food had hard bite and texture and was less crisp. However, it was better than the product prepared without fat as in Example-1.

Objective evaluation showed that the product had a width of 50.0 mm and a thickness of 3.15 mm. Objective measurement of the texture showed that it had a breaking strength of 1.68 Kg.

| | | | | Breaking |
|---|---|---|---|---|
| | Width (W), | Thickness (T) | Spread ratio | strength |
| Sample | (mm) | (mm) | (W/T) | (Kg Force) |
| 10.0% Fat | 50.0 | 3.15 | 15.87 | 1.68 |

### EXAMPLE-3

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Subjective evaluation showed that the surface of the product was very smooth without any blisters. The product also had appealing appearance. The product had optimum crispness with good, wholesome mouthfeel.

Objective evaluation showed that the snack food had a width of 50.0 mm and a thickness of 3.1 mm. The spread ratio of the product was 16.1. The product had a breaking strength of 1.39 Kg.

| | | | | Breaking |
|---|---|---|---|---|
| | Width (W), | Thickness (T) | Spread ratio | strength |
| Sample | (mm) | (mm) | (W/T) | (Kg Force) |
| 12.0% Fat | 50.0 | 3.1 | 16.1 | 1.39 |

### EXAMPLE-4

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 15.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

The product had smooth surface and good appearance. The texture of the product was fragile. The snack food was slightly thin hence had less acceptable bite and mouthfeel.

Objective measurement showed that the product had a width of 51 mm and a thickness of 2.8 mm. Breaking strength of the product was 1.16 Kg.

| | | | | Breaking |
|---|---|---|---|---|
| | Width (W), | Thickness (T) | Spread ratio | strength |
| Sample | (mm) | (mm) | (W/T) | (Kg Force) |
| 15.0% Fat | 51.0 | 2.8 | 18.2 | 1.16 |

### EXAMPLE-5

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut grits (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

The present experiment was conducted using peanut grits in the formulation. The subjective evaluation showed that the product had rough and non uniform surface because of the presence of peanut grits. The product was slightly fragile and broke easily.

Presence of peanut grits adversely affected sheeting properties of the dough where formation of a dough sheet of required thickness was cumbersome. Due to the presence of peanut grits the dough broke frequently during the sheeting process.

The objective evaluation of the snack food showed that it had a spread of 50.0 mm and thickness of 3.1 mm. The texture analysis showed that it had a breaking strength of 1.22 Kg.

| | | | | Breaking |
|---|---|---|---|---|
| | Width (W), | Thickness (T) | Spread ratio | strength |
| Sample | (mm) | (mm) | (W/T) | (Kg Force) |
| Peanut grits | 50.0 | 3.1 | 16.1 | 1.22 |

### EXAMPLE-6

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

In the present experiment roasted peanut was made into a paste in an electric grinder. The peanut paste was included in the formulation. The results showed that presence of peanut paste produced a more homogenous and smooth dough which facilitated the continuous sheeting operations. The sheeted dough was smooth, even and unbroken and further facilitated in the moulding operations of the dough.

The subjective evaluation of the product showed that it had even and uniform surface and wholesome appearance. The product was crisp in texture and had good mouthfeel.

The objective evaluation of the product showed that it had a width of 50.0 mm and a thickness of 3.1 mm. The breaking strength of the snack food was 1.39 Kg.

| | | | | Breaking |
|---|---|---|---|---|
| | Width (W), | Thickness (T) | Spread ratio | strength |
| Sample | (mm) | (mm) | (W/T) | (Kg Force) |
| Peanut paste | 50.0 | 3.1 | 16.1 | 1.39 |

### EXAMPLE-7

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 5.0 |
| sesame seeds) | |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

In the present experiment only sesame seed paste was included in the formulation. Subjective evaluation showed that the product had a smooth surface. However, the product had a plain and unattractive appearance. The biting quality and mouthfeel of the product were very smooth and less desirable.

Objective evaluation showed that the product had a width of 50.0 mm and a thickness of 3.1 mm. The breaking strength of the product was 1.40 kg.

| | | | | Breaking |
|---|---|---|---|---|
| | Width (W), | Thickness (T) | Spread ratio | strength |
| Sample | (mm) | (mm) | (W/T) | (Kg Force) |
| Sesame seed | 50.0 | 3.1 | 16.1 | 1.40 |
| paste | | | | |

### EXAMPLE-8

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seeds (roasted) | 5.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

In the present experiment roasted sesame seeds were added as such without making it into a paste. The results showed that the appearance of the product was not very appealing. The product was also slightly gritty and less crisp.

The objective evaluation showed that the product had a width of 50.0 mm and a thickness of 3.1 mm. The breaking strength of the product was 1.48 Kg.

| | | | | Breaking |
|---|---|---|---|---|
| | Width (W), | Thickness (T) | Spread ratio | strength |
| Sample | (mm) | (mm) | (W/T) | (Kg Force) |
| Sesame seed | 50.0 | 3.1 | 16.1 | 1.48 |

### EXAMPLE-9

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Subjective evaluation showed that the surface of the product was attractive. The product had optimum crispness and good wholesome mouthfeel. The product had very pleasing aroma and taste.

Objective evaluation showed that the snack food had a width of 50.0 mm and a thickness of 3.1 mm. The spread ratio of the product was 16.1. The product had a breaking strength of 1.39 Kg.

| | Width | | | Breaking |
|---|---|---|---|---|
| | (W), | Thickness (T) | Spread ratio | strength |
| Sample | (mm) | (mm) | (W/T) | (Kg Force) |
| Sesame seed | 50.0 | 3.1 | 16.1 | 1.39 |
| paste - 3% + | | | | |
| Sesame seed - 2% | | | | |

### EXAMPLE-10

Ingredients and the quantity used in the following example are given below.

| INGREDIENTS | QUANTITY (g) |
|---|---|
| Roasted whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 80.0 |

The requirement of water for the preparation of dough was more. The dough prepared was very hard. Mixing and production of homogenous dough mass was very difficult. It was also very difficult to sheet the dough to desired thickness. The dough was getting broken during the sheeting operations.

The subjective evaluation of the product prepared from the above dough showed that it had very dark surface colour which was not acceptable. The product had less spread and was thin hence did not have a good bite and mouthfeel. Because of its thin nature the product was fragile and easily broken.

Product was not crisp but hard to chew.

The objective evaluation showed that the product had a width of 48.3 mm and thickness of 2.7 mm. The breaking strength of the product was 0.98 Kg.

| | | | | Breaking |
|---|---|---|---|---|
| | Width (W), | Thickness (T) | Spread ratio | strength |
| Sample | (mm) | (mm) | (W/T) | (Kg Force) |
| Roasted | 48.3 | 2.7 | 17.89 | 0.98 |
| whole wheat | | | | |
| flour | | | | |

### EXAMPLE-11

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

In the present experiment unroasted whole wheat flour was used in the formulation. Water requirement for the preparation of the dough was relatively very less. Mixing of the dough was easy which formed into a smooth homogenous mass. Sheeting of the dough to desired thickness was not difficult. During the sheeting operations dough stretched into a smooth sheet of desired thickness without breaking.

Subjective evaluation showed that the product had appealing appearance with optimum surface color, thickness and spread. The product had optimum crispness with good, wholesome mouthfeel.

Objective evaluation showed that the snack food had a width of 50.0 mm and a thickness of 3.1 mm. The spread ratio of the product was 16.1. The product had a breaking strength of 1.39 Kg.

| | | | | Breaking |
|---|---|---|---|---|
| | Width (W), | Thickness (T) | Spread ratio | strength |
| Sample | (mm) | (mm) | (W/T) | (Kg Force) |
| Whole wheat | 50.0 | 3.1 | 16.1 | 1.39 |
| flour (un- | | | | |
| roasted) | | | | |

### EXAMPLE-12

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Three experiments were conducted to determine the optimum thickness for the snack food.

In the first experiment the prepared dough was sheeted to a thickness of 1.5 mm. Subjective evaluation showed that the product lacked in having s good bite, mouthfeel and wholesome eating properties. The product was considered to be slightly thin.

The objective evaluation showed that it had a width of 50.0 mm and a thickness of 2.6 mm. The breaking strength of the product was 1.10 Kg.

In the second experiment the prepared dough was sheeted to a thickness of 1.75 mm. Subjective evaluation showed that the product had a good bite, mouthfeel, and wholesome eating properties.

The objective evaluation showed that the snack food had a width of 50.0 mm and a thickness 3.1 mm. The breaking strength of the product was 1.39 Kg.

In the third experiment the dough was sheeted to a thickness of 2.0 mm. The subjective evaluation showed the product had slightly hard texture and less crisp.

Objective evaluation showed that the product had a width or 50 mm and a thickness of 3.3 mm. The breaking strength of the snack food was 1.54 Kg.

| | | | | Breaking |
|---|---|---|---|---|
| Thickness | Width (W), | Thickness (T) | Spread ratio | strength |
| (mm) | (mm) | (mm) | (W/T) | (Kg Force) |
| 1. 1.50 | 50.0 | 2.6 | 19.2 | 1.10 |
| 2. 1.75 | 50.0 | 3.1 | 16.1 | 1.39 |
| 3. 2.00 | 50.0 | 3.3 | 15.2 | 1.54 |

### EXAMPLE-13

Ingredients and the quantity used in the following example are given below.

| INGREDIENTS | QUANTITY (g) |
|---|---|
| Whole wheat flour | 75.0 |
| Roasted (defatted) soy flour | 25.0 |
| Peanut paste (from roasted and | 10.0 |
| dehulled peanuts) | |
| Sesame seed paste (from roasted | 3.0 |
| sesame seeds) | |
| Sesame seeds (roasted) | 2.0 |
| Wheat germ (roasted) | 5.0 |
| Non Fat Dry Milk | 5.0 |
| Sugar powder | 40.0 |
| Liquid glucose | 2.5 |
| Fat | 12.0 |
| Lecithin (soy) | 0.2 |
| Sodium chloride | 1.0 |
| Baking powder | 0.4 |
| Ammonium bicarbonate | 1.0 |
| Cardamom flavour (ml) | 0.2 |
| Vitamin premix | 0.032 |
| Mineral Premix | 0.021 |
| Water | 50.0 |

Two experiments were conducted to determine the optimum mixing method for the preparation of the dough.

In the first experiment sugar powder, fat, peanut paste, sesame seed paste, lecithin, and flavour were creamed in a mixer until a smooth and homogenous paste was formed. To the above cream, leavening agent and sodium chloride dissolved in formula water were added and mixed further until a homogenous paste was formed. Rest of the ingredients were added to the above paste, including wheat flour-soy flour-milk powder-baking powder blend, mineral and vitamin premix, sesame seed, wheat germ, liquid glucose and mixed further until a homogenous dough was formed. The dough was sheeted to a thickness of 1.75 mm, docked, cut and baked.

Subjective evaluation showed that the product had less spread, was not crisp but had a relatively hard texture.

Objective evaluation of the product showed that it had a width of 49.6 mm and a thickness of 3.2 mm. The breaking strength of the product was 1.58 Kg.

In the second experiment blend of wheat flour-soy flour-milk powder-baking powder, vitamin and mineral premix, leavening agent and sodium chloride dissolved in water, and rest of the other formula ingredients were transferred into a mixer and mixed till a homogenous dough was formed. The dough was sheeted to a thickness of 1.75 mm, docked, cut and baked.

Subjective evaluation showed that the product had optimum crispness with good, wholesome mouthfeel.

Objective evaluation showed that the snack food had a width of 50.0 mm and a thickness of 3.1 mm. The spread ratio of the product was 16.1. The product had a breaking strength of 1.39 Kg.

| | | | Spread | Breaking |
|---|---|---|---|---|
| | Width (W), | Thickness (T) | ratio | strength |
| Mixing method | (mm) | (mm) | (W/T) | (Kg Force) |
| 1. Creaming | 49.6 | 3.2 | 15.5 | 1.58 |
| 2. All-in-one | 50.0 | 3.1 | 16.1 | 1.39 |

High protein nutritious baked snack food thus prepared using specific protein sources and well balanced mixture of vitamins and minerals in the formulation has the following advantages.
1. Provides a ready-to-eat nutritious snack food.
2. The snack food contains proteins from vegetable sources only.
3. Provides essential amino acids such as lysine and methionine.
4. The snack food provides 18.0 g protein, and 460 calories from 100 g snack food on dry weight basis.
5. The snack food contains well balanced mixture of selected vitamins.
6. The snack food contains well balanced mixture of selected minerals.
7. Since the snack food is baked less changes of fungal or bacterial contamination. Hence more hygienic.
8. Since the moisture content of the snack food is relatively low (3.5%) it has a very long shelf life.

1. A composition for a high protein nutritional baked snack food comprising:

| | | |
|---|---|---|
| Whole wheat flour | 42.41-40.38 | wt % |
| Roasted (defatted) soy flour | 18.18-10.10 | wt % |
| Peanut paste (from roasted | 4.85-6.06 | wt % |
| peanuts) | | |
| Sesame seed paste (from roasted | 1.21-2.02 | wt % |
| Sesame seeds) | | |
| Sesame seed (roasted) | 0.61-1.51 | wt % |
| Wheat germ (roasted) | 1.82-3.53 | wt % |
| Non fat dry milk (fat content <1%) | 1.82-3.53 | wt % |
| Sugar powder (+120μ sieve) | 21.21-22.71 | wt % |
| Liquid glucose | 1.21-1.51 | wt % |
| Fat (M.P. 40° C.) | 5.45-6.56 | wt % |
| Lecithin (soy) | 0.18-0.25 | wt % |
| Sodium Chloride | 0.3-0.76 | wt % |
| Ammonium bicarbonate | 0.48-0.61 | wt % |
| Baking powder | 0.18-0.28 | wt % |
| Flavoring agents (ml) | 0.06-0.15 | wt % |
| (cardamom flavor) | | |
| Iron | 3.49-3.57 | g wt % |
| Zinc | 7.50-7.65 | g wt % |
| Copper | 0.25-0.26 | g wt % |
| Iodine | 0.097-0.101 | g wt % |
| Magnesium | 0.48-0.49 | g wt % |
| Vitamin - A | 0.14-0.141 | g wt % |
| Vitamin - D | 0.0035-0.0036 | g wt % |
| Vitamin - E | 0.25-0.257 | g wt % |
| Vitamin - K | 0.29-0.302 | g wt % |
| Vitamin B1 (Thiamine) | 0.25-0.257 | g wt % |
| Vitamin B2 (Riboflavin) | 0.28-0.288 | g wt % |
| Nicotinic acid | 2.50-2.55 | g wt % |
| Pyridoxine | 0.29-0.308 | g wt % |
| Folic acid | 0.009-0.010 | g wt % |
| Pantothenic acid | 0.0003-0.000302 | g wt % |
| Vitamin - C | 11.99-12.24 | g wt % |
| Biotin | 0.096-0.10 | g wt % |
| Inositol | 0.499-0.509 | g wt % |
| Choline bitartarate | 1.248-1.272 | g wt % |
| Vitamin - B12 | 0.00028-0.00038 | g wt % |

2. A process for the preparation of high protein nutritious baked snack food according to claim (1) comprising (i) powdering the wheat kernels in a disc mill resulting in whole wheat flour to pass through 10xx (129μ) sieve, (ii) roasting the defatted soy flour in a fluidized bed roaster for a period of 5-12 minutes at 200-220° C., (iii) roasting of peanuts in a fluidized bed roaster for a period of 5-15 minutes at 280-320° C., (iv) dehulling of roasted peanuts in a brush finisher, (v) converting the roasted and dehulled peanuts into a fine paste in an electric grinder, (vi) roasting of sesame seeds in a fluidized bed roaster for a period of 4-6 minutes at 280-320° C., (vii) converting required portion of roasted sesame seeds into a fine paste in an electric grinder, (viii) roasting of wheat germ in a fluidized bed roaster for a period of 3-5 minutes at 280-320° C., (ix) homogenous mixing of vitamins namely, vitamin A, vitamin D, vitamin E, vitamin K, vitamin B1 (thiamine), vitamin B2 (riboflavin), nicotinic acid, pyridoxine, folic acid, pantothenic acid, biotin, inositol, choline bitartarate, vitamin B12 and vitamin C, and minerals, namely, iron, zinc, copper, iodine and magnesium, along with 200-300 g of whole wheat flour for a period of 5-10 minutes to form the vitamin and mineral premix, (x) preparing a blend of 70-80% by weight of whole wheat flour, 20-30% by weight of roasted defatted soy flour, 4-6% by weight of non fat dry milk, and 0.3-0.5% by weight of baking powder, (xi) dissolving ammonium bicarbonate and sodium chloride in formula water, (xii) transferring peanut paste from step-v, sesame seed paste from step-vii, roasted wheat germ from step-viii, vitamin and mineral premix from step-ix, blend of whole wheat flour, soy flour, milk powder and baking powder from step-x, other ingredients such as roasted whole sesame seed, sugar powder, fat, liquid glucose, lecithin, flavoring agent, ammonium bicarbonate and sodium chloride dissolved in formula water as obtained in step-xi, into a mixer and mixing for 15-20 minutes into a homogenous dough, (xiii) sheeting the dough to a thickness of 1.5 mm-2.0 mm, (xiv) docking and cutting the sheeted dough into circular shape, (xv) baking in a conventional oven at 180-220° C. for 4-6 minutes to get the high protein nutritious baked snack food.

3. A process as claimed in claim (2) wherein commercially available wheat used is with 9.0-10.0% moisture, 1.1-1.5% ash, 9.2-10.0% protein content.

4. A process as claimed in claim (2) wherein wheat kernels are processed into flour in a disc mill to pass through 10 xx (129μ) sieve.

5. A process as claimed in claim (2) wherein defatted soy flour is roasted in a fluidized bed roaster at 200-220° C. for a period of 5-12 minutes.

6. A process as claimed in claim (2) wherein peanuts are roasted in a fluidized bed roaster maintained at 280-320° C. for 5-15 minutes.

7. A process as claimed in claim (6) wherein roasted peanuts are dehulled in a brush finisher.

8. A process as claimed in claim (7) wherein roasted and dehulled peanuts are made into a fine paste in an electric grinder.

9. A process as claimed in claim (2) wherein sesame seeds are roasted in a fluidized bed roaster for a period of 4-6 minutes at 280-320° C.

10. A process as claimed in claim (9) wherein required portion of the roasted sesame seeds are made into a fine paste in an electric grinder.

11. A process as claimed in claim (2) wherein wheat germ is roasted in a fluidized bed roaster for a period of 3-5 minutes at 280-320° C.

12. A process as claimed in claim (2) wherein vitamins namely, vitamin A, vitamin D, vitamin E, vitamin K, vitamin B1 (thiamin), vitamin B2 (riboflavin), nicotonic acid, pyridoxine, folic acid, pantothenic acid, biotin, inositol, choline bitartarate, vitamin B12 and vitamin C; and minerals namely iron, zinc, copper, iodine and magnesium are mixed into a homogenous blend along with 200-300 g of whole wheat flour for a period of 5-10 min to obtain the vitamin and mineral premix.

13. A process as claimed in claim (1) wherein whole wheat flour, roasted defatted soy flour, non fat dry milk and baking powder are thoroughly mixed for about 10-12 minutes into a homogenous mixture.

14. A process as claimed in claim (2) wherein ammonium bicarbonate and sodium chloride are dissolved in formula water.

15. A process according to claim (1) wherein peanut paste, sesame seed paste, roasted wheat germ, vitamin-mineral premix, blend of whole wheat flour-soy flour-milk powder-baking powder, roasted sesame seed, sugar powder, fat, liquid glucose, lecithin, flavoring agent, ammonium bicarbonate and sodium chloride dissolved in formula water are transferred to a mixer and mixed for 15-20 minutes into a homogenous dough.

16. A process as claimed in claim (1) wherein the dough is sheeted to a thickness of 1.5-2.0 mm.

17. A process as claimed in claim (16) wherein sheeted dough is docked and cut using a circular die of about 3.0-4.0 mm diameter.

18. A process as claimed in claim (17) wherein the cut dough is baked in a conventional oven at 180-220° C. for 4-6 minutes to get the high protein nutritious baked snack food.

19. A process according to claim (1) wherein the snack food is cooled and packed.

20. A process as claimed in claim (2) wherein whole wheat flour, roasted defatted soy flour, non fat dry milk and baking powder are thoroughly mixed for about 10-12 minutes into a homogenous mixture.

21. A process according to claim (2) wherein peanut paste, sesame seed paste, roasted wheat germ, vitamin-mineral premix, blend of whole wheat flour-soy flour-milk powder-baking powder, roasted sesame seed, sugar powder, fat, liquid glucose, lecithin, flavoring agent, ammonium bicarbonate and sodium chloride dissolved in formula water are transferred to a mixer and mixed for 15-20 minutes into a homogenous dough.

22. A process as claimed in claim (2) wherein the dough is sheeted to a thickness of 1.5-2.0 mm.

23. A process as claimed in claim (22) wherein sheeted dough is docked and cut using a circular die of about 3.0-4.0 mm diameter.

24. A process as claimed in claim (23) wherein the cut dough is baked in a conventional oven at 180-220° C. for 4-6 minutes to get the high protein nutritious baked snack food.

25. A process according to claim (2) wherein the snack food is cooled and packed.
